(19) United States
(12) Patent Application Publication
(10) Pub. No.: US 2019/0041718 A1
(43) Pub. Date: Feb. 7, 2019

(54) LIGHT CONTROL DEVICE

(71) Applicant: PANASONIC INTELLECTUAL PROPERTY MANAGEMENT CO., LTD., Osaka (JP)

(72) Inventors: Tomonori YAMADA, Osaka (JP); Hirofumi KUBOTA, Osaka (JP); Jumpei MATSUZAKI, Hyogo (JP); Yoshichika OSADA, Osaka (JP); Yuko SUZUKA, Kyoto (JP)

(73) Assignee: PANASONIC INTELLECTUAL PROPERTY MANAGEMENT CO., LTD., Osaka (JP)

(21) Appl. No.: 15/564,076

(22) PCT Filed: Mar. 17, 2016
(86) PCT No.: PCT/JP2016/001527

§ 371 Date: Oct. 3, 2017

(30) Foreign Application Priority Data
Apr. 7, 2015 (JP) 2015-078714

(51) Int. Cl. G02F 1/29; E06B 9/24; G02F 1/1347; G02F 1/1343

(52) U.S. Cl. CPC G02F 1/29; G02F 1/1343; G02F 1/1347; E06B 9/24

(57) ABSTRACT

A light control device disposed between an outdoor area and an indoor area includes: a light-transmissive first electrode; a light-transmissive second electrode; a refractive-index control layer located between the first electrode and the second electrode, and having a controllable refractive index; and a light-transmissive recessed and protruding layer located between the first electrode and the refractive-index control layer, and including repeating protrusions, wherein the light control device is disposed such that the first electrode is on an outdoor area side, the repeating protrusions each have an inclined surface inclined at a predetermined angle of inclination, relative to a thickness direction of the light control device, and the angles of inclination of one of the repeating protrusions and another of the repeating protrusions are different in a recurrent direction of the repeating protrusions.

### TECHNICAL FIELD

The present invention relates to a light control device.

### BACKGROUND ART

A light control device which changes a direction of travel of incident sunlight from an outdoor area and allows the sunlight to come into an indoor area has been proposed. For example, Patent Literature (PTL) 1 discloses a lighting sheet disposed at a window so that the lighting sheet can change a direction of travel of sunlight which is to enter an indoor area through the window and direct the sunlight to the indoor ceiling, for instance. The lighting sheet disclosed in PTL 1 is obtained by forming a reflective surface by filling recessed grooves formed in a transparent sheet material with a filler, and reflects sunlight by the reflective surface to bend the light path of the sunlight to allow the sunlight to come into the indoor area.

### CITATION LIST

### Patent Literature

PTL 1: Japanese Unexamined Patent Application Publication No. 2012-255951

### SUMMARY OF THE INVENTION

### Technical Problem

However, although the lighting sheet disclosed in PTL 1 can change the direction of travel of incident sunlight and allow the sunlight to come into an indoor area, the lighting sheet cannot allow incident sunlight to come into the indoor area as the sunlight travels, without changing the direction of travel of the sunlight.

Stated differently, the lighting sheet disclosed in PTL 1 cannot switch between a light distributing state in which light is caused to change a direction of travel and passes through, and a transparent state in which light is allowed to pass through without changing a direction of travel.

With regard to light control devices, there are various demands that sunlight is to be allowed to come into an indoor area in such a manner that a person near a window in the indoor area does not feel sunlight is too bright or that sunlight is to be caused to reach even a spot far from the window in the indoor area.

An object of the present invention is to provide a light control device which can switch between the light distributing state and the transparent state and furthermore, can change the direction of incident light to different directions and cause the incident light to travel in the directions.

### Solution to Problem

In order to achieve the above object, a light control device according to an aspect of the present invention is a light control device disposed between an outdoor area and an indoor area, the light control device including: a first electrode which is light-transmissive; a second electrode which is light-transmissive; a refractive-index control layer located between the first electrode and the second electrode, and having a refractive index that is controllable; and a recessed and protruding layer located between the first electrode and the refractive-index control layer, and including repeating protrusions, the recessed and protruding layer being light-transmissive, wherein the light control device is disposed such that the first electrode is on an outdoor area side, the repeating protrusions each have an inclined surface which is inclined at an angle of inclination that is predetermined, relative to a thickness direction of the light control device, and the angle of inclination of one of the repeating protrusions and the angle of inclination of another of the repeating protrusions are different from each other in a recurrent direction of the repeating protrusions.

### Advantageous Effect of Invention

According to the present invention, a light distributing state in which light is caused to change a direction of travel and passes through and a transparent state in which light is allowed pass through without changing a direction of travel can be switched and furthermore, in the light distributing state, the direction of incident light can be changed to different directions, and the light travels in the directions.

### BRIEF DESCRIPTION OF DRAWINGS

FIG. 1 is a cross-sectional view of a light control device according to Embodiment 1.

FIG. 2 is an enlarged partial cross-sectional view of the light control device according to Embodiment 1.

FIG. 3A is an enlarged partial cross-sectional view schematically illustrating a state in which the light control device according to Embodiment 1 is in a transparent state.

FIG. 3B is an enlarged partial cross-sectional view schematically illustrating a state in which the light control device according to Embodiment 1 is in a light distributing state.

FIG. 4 is an enlarged partial cross-sectional view of the light control device according to Embodiment 1 in the light distributing state.

FIG. 5 is an explanatory diagram of optical operation of a light control device according to a comparative example.

FIG. 6 is an explanatory diagram of optical operation of the light control device according to Embodiment 1.

FIG. 7 is an explanatory diagram of other optical operation of the light control device according to Embodiment 1.

FIG. 8 is an enlarged partial cross-sectional view of a light control device according to Embodiment 2.

FIG. 9A is an enlarged partial cross-sectional view schematically illustrating a state of the light control device according to Embodiment 2 in the transparent state.

FIG. 9B is an enlarged partial cross-sectional view schematically illustrating a state of the light control device according to Embodiment 2 in the light distributing state.

FIG. 10 is an enlarged partial cross-sectional view of a light control device according to Embodiment 3.

FIG. 11A is an enlarged partial cross-sectional view schematically illustrating a state of a light control device according to Embodiment 3 in the transparent state.

FIG. 11B is an enlarged partial cross-sectional view schematically illustrating a state of the light control device according to Embodiment 3 in the light distributing state.

FIG. 12 is an enlarged partial cross-sectional view of a light control device according to Variation 1.

FIG. 13 is a cross-sectional view of a light control device according to

Variation 2.

### DESCRIPTION OF EXEMPLARY EMBODIMENTS

The following describes embodiments of the present invention with reference to the drawings. Note that the embodiments described below each illustrate a particular preferable example of the present invention. Thus, the numerical values, shapes, materials, elements, the arrangement and connection of the elements, and others indicated in the following embodiments are examples, and are not intended to limit the present invention. Therefore, among the elements in the following embodiments, elements not recited in any of the independent claims defining the most generic concept of the present invention are described as arbitrary elements.

The drawings are schematic diagrams and do not necessarily give strict illustration. Accordingly, for example, scales are not necessarily the same in the drawings. Note that throughout the drawings, the same numeral is given to substantially the same element, and redundant description is omitted or simplified.

### EMBODIMENT 1

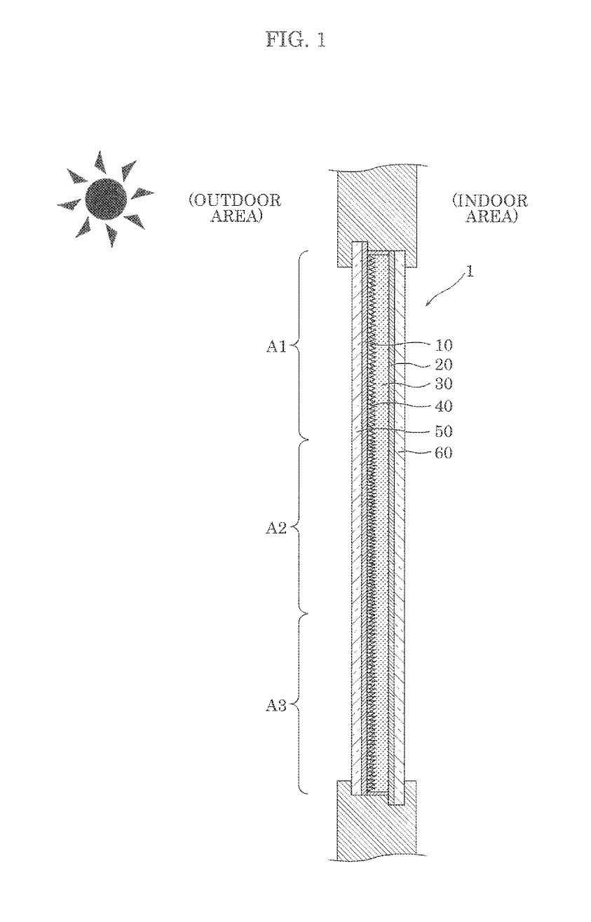

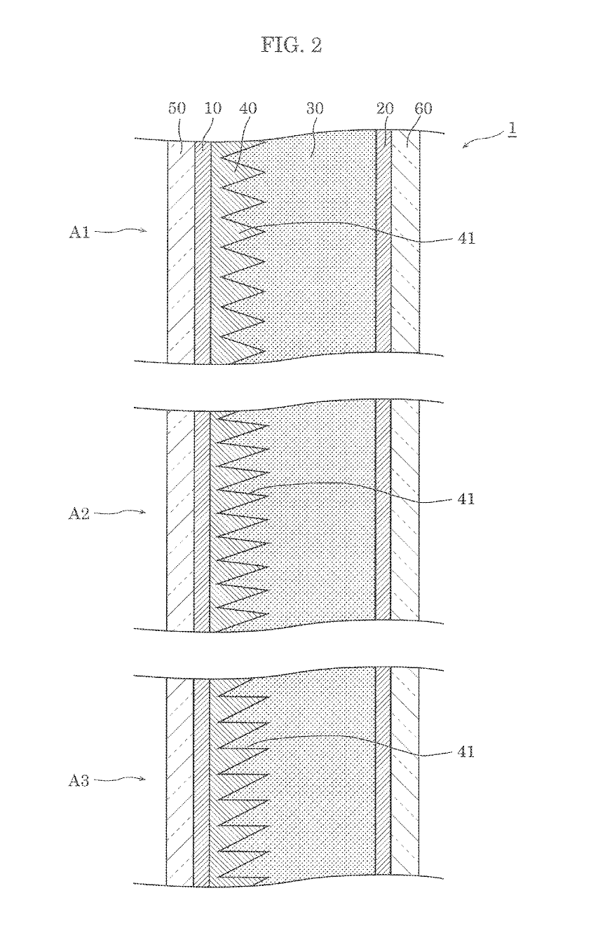

The first describes a configuration of light control device 1 according to Embodiment 1, with reference to FIGS. 1 and 2. FIG. 1 is a cross-sectional view of light control device 1 according to Embodiment 1. FIG. 2 is an enlarged partial cross-sectional view of light control device 1 according to Embodiment 1, and illustrates an enlarged portion of FIG. 1.

As illustrated in FIGS. 1 and 2, light control device 1 is a light distribution control device which can control distribution of light, and includes first electrode 10 and second electrode 20 that form a pair, refractive-index control layer 30, and recessed and protruding layer 40. Light control device 1 further includes first substrate 50, and second substrate 60.

In light control device 1, first electrode 10, recessed and protruding layer 40, refractive-index control layer 30, and second electrode 20 are disposed in the thickness direction in this order between first substrate 50 and second substrate 60. Note that in this specification, the “thickness direction” means the thickness direction of light control device 1, and is a direction perpendicular to the major surfaces of first substrate 50 and second substrate 60.

As illustrated in FIG. 1, light control device 1 is disposed between an outdoor area (outside of a room) and an indoor area (inside of a room), for example. In the present embodiment, light control device 1 is disposed such that first electrode 10 is on the outdoor area side and second electrode 20 is on the indoor area side. Specifically, light control device 1 is disposed such that first substrate 50 on which first electrode 10 and recessed and protruding layer 40 are formed is on the outdoor area side.

Light control device 1 may be used as a substitute for a window of a building as illustrated in FIG. 1, or may be disposed facing a window of a building. FIG. 1 illustrates an example in which light control device 1 is fixed to the outer wall of a building as a window. Note that light control device 1 is not limited to a window of a building, and may be used as a window of a movable object, examples of which include an airplane and vehicles including a car and a train. If light control device 1 is used as a window of a vehicle, an outdoor area means the outside of the vehicle and an indoor area means the inside of the vehicle.

The following describes in detail members included in light control device 1.

### [First Electrode, Second Electrode]

First electrode 10 and second electrode 20 electrically form a pair, and are configured to apply an electric field to refractive-index control layer 30.

First electrode 10 and second electrode 20 are light-transmissive, and thus transmit incident light. First electrode 10 and second electrode 20 are transparent conductive layers, for example. As the material of the transparent conductive layer, the following can be used: a transparent metal oxide such as indium tin oxide (ITO) and indium zinc oxide (IZO); a conductive-material containing resin which includes a resin that contains conductive material such as a silver nanowire and conductive particles; and a metal thin film such as a silver thin film.

Note that first electrode 10 and second electrode 20 may each have a structure which includes a single layer that includes such a material, or a structure in which layers that include such materials are stacked (for example, a structure in which a transparent metal oxide and a metal thin film are stacked). In order to prevent uneven luminance on light-emitting surfaces of first electrode 10 and second electrode 20 due to voltage drop, narrow auxiliary wiring which includes, for instance, a low-resistance metal material may be disposed on the surfaces of first electrode 10 and second electrode 20.

First electrode 10 is disposed between first substrate 50 and recessed and protruding layer 40. Second electrode 20 is disposed between second substrate 60 and refractive-index control layer 30. In addition, first electrode 10 and second electrode 20 not only electrically form a pair, but are disposed in a paired manner so as to be located opposite each other. Specifically, first electrode 10 is disposed in a film form on the surface of first substrate 50, and second electrode 20 is disposed in a film form on the surface of second substrate 60 located opposite first substrate 50.

First electrode 10 and second electrode 20 may be configured to be electrically connected with an external power supply. For example, electrode pads for connecting with an external power supply are drawn from first electrode 10 and second electrode 20, and formed on first substrate 50 or second substrate 60. The electrode pads may be portions of first electrode 10 and second electrode 20.

### [Refractive-Index Control Layer]

Refractive-index control layer (refractive index variable layer) 30 has a controllable refractive index for light in a visible light range. Refractive-index control layer 30 includes a material whose refractive index changes by the application of an electric field (refractive index variable material). In the present embodiment, refractive-index control layer 30 includes a liquid crystal material which mainly includes liquid crystal molecules. Thus, the liquid crystal material is used as a refractive index variable material. Examples of the liquid crystal material include a nematic liquid crystal or a cholesteric liquid crystal in which liquid crystal molecules are rod-shaped. The orientation state of liquid crystal molecules changes due to a change in electric field, whereby the refractive index of a liquid crystal material changes. In the present embodiment, a negative nematic liquid crystal is used as a liquid crystal material.

Refractive-index control layer 30 is located between first electrode 10 and second electrode 20, and an electric field is applied to refractive-index control layer 30 by the application of a voltage to first electrode 10 and second electrode 20. Controlling a voltage applied to first electrode 10 and second electrode 20 changes an electric field applied to refractive-index control layer 30, whereby the orientation state of liquid crystal molecules changes. Accordingly, the refractive index of refractive-index control layer 30 changes. Specifically, the refractive index of refractive-index control layer 30 changes between two refractive indexes, namely a refractive index having a value the same as or close to the refractive index of recessed and protruding layer 40, and a refractive index greatly different from the refractive index of recessed and protruding layer 40.

Such a change in the refractive index of refractive-index control layer 30 changes the state of refractive-index control layer 30 to a plurality of states including a transparent state (transparent mode) in which light is allowed to pass through as it is without changing a direction of travel, and a light distributing state (light distributing mode) in which light is caused to change a direction of travel (distributed) and passes through. In the light distributing state, the direction of incident light is changed to a direction in which the light bounces off, for example.

In the present embodiment, the state of refractive-index control layer 30 can be changed between two states, namely the transparent state and the light distributing state. Specifically, when the refractive index of refractive-index control layer 30 is the same as or close to the refractive index of recessed and protruding layer 40, refractive-index control layer 30 is in the transparent state, whereas when a difference in the refractive index between refractive-index control layer 30 and recessed and protruding layer 40 is great, refractive-index control layer 30 is in the light distributing state. To place refractive-index control layer 30 into the transparent state, a difference in the refractive index between refractive-index control layer 30 and recessed and protruding layer 40 may be less than or equal to 0.2, more preferably less than or equal to 0.1, and still more preferably 0. In the present embodiment, when refractive-index control layer 30 is in the transparent state, the following equation is satisfied: Na=Nb (difference in refractive index is 0), where Na denotes the refractive index of refractive-index control layer 30 and Nb denotes the refractive index of recessed and protruding layer 40.

On the other hand, to place refractive-index control layer 30 into the light distributing state, a difference in the refractive index between refractive-index control layer 30 and recessed and protruding layer 40 is at least greater than 0.1, and is preferably greater than or equal to 0.2. In the present embodiment, the refractive index (Na) of refractive-index control layer 30 and the refractive index (Nb) of recessed and protruding layer 40 satisfy Na>Nb when refractive-index control layer 30 is in the transparent state. As an example, when recessed and protruding layer 40 having a refractive index of 1.5 (Nb=1.5) is used, the refractive index of refractive-index control layer 30 can be set to 1.5 (Na=Nb=1.5) when an electric field is not applied (in the transparent state), and can be set to about 1.7 (Na=1.7>Nb) when an electric field is applied (in the light distributing state).

Note that an electric field may be applied to refractive-index control layer 30 using alternating-current (ac) power or direct-current (dc) power. When ac power is used, a voltage waveform may be a sine wave or a square wave.

A surface of refractive-index control layer 30 on the recessed and protruding layer 40 side (surface of refractive-index control layer 30 on the first substrate 50 side) is a recessed and protruding surface due to recesses and protrusions of recessed and protruding layer 40. Specifically, protrusions 41 of refractive-index control layer 30 correspond to recesses of recessed and protruding layer 40, and the recesses of refractive-index control layer 30 correspond to protrusions 41 of recessed and protruding layer 40.

### [Recessed and Protruding Layer]

Recessed and protruding layer 40 is located between first electrode 10 and refractive-index control layer 30. In the present embodiment, recessed and protruding layer 40 is in contact with first electrode 10 and refractive-index control layer 30.

Recessed and protruding layer 40 is light-transmissive, and thus transmits incident light. Stated differently, light that enters recessed and protruding layer 40 through first electrode 10 passes through recessed and protruding layer 40, and enters refractive-index control layer 30. Recessed and protruding layer 40 and first electrode 10 may be configured such that a difference in the refractive index is small for light in a visible light range. Such a configuration effectively allows light to pass through the interface between recessed and protruding layer 40 and first electrode 10, and improves transparency of light control device 1 in the transparent state. For example, a difference in the refractive index between recessed and protruding layer 40 and first electrode 10 may be less than or equal to 0.2, and more preferably less than or equal to 0.1. The refractive index of recessed and protruding layer 40 is in a range from 1.3 to 2.0, for example, but is not limited to the range. In the present embodiment, the refractive index of recessed and protruding layer 40 is 1.5.

Recessed and protruding layer 40 has a recessed and protruding surface having repeating protrusions 41. Specifically, recessed and protruding layer 40 includes aligned protrusions 41 that protrude toward refractive-index control layer 30. A surface of recessed and protruding layer 40 on the first electrode 10 side is flat, whereas a surface of recessed and protruding layer 40 on the refractive-index control layer 30 side is the recessed and protruding surface. Note that in the present embodiment, a recurrent direction of protrusions 41 is a vertical direction, and protrusions 41 are regularly aligned.

The height of each protrusion 41 (depth of each recess) of recessed and protruding layer 40 can be in a range from 100 nm to 100 μm, but is not limited to this range. The spacing between the apexes of adjacent protrusions 41 (distance between recesses and protrusions) can be in a rage from 100 nm to 100 μm, for example, but is not limited to this range. Recesses and protrusions of recessed and protruding layer 40 can be formed by imprinting, for example. For example, recessed and protruding layer 40 is formed in first electrode 10. Note that recessed and protruding layer 40 can be readily formed if the distance between recesses and protrusions is shorter than the height of protrusions 41.

Protrusions 41 each have an inclined surface which is inclined at a predetermined angle of inclination relative to the thickness direction. The inclined surface of protrusion 41 is a boundary surface (interface) between refractive-index control layer 30 and recessed and protruding layer 40. Light which travels from recessed and protruding layer 40 to refractive-index control layer 30 is reflected by or is not reflected by and just passes through the inclined surface of protrusion 41, according to a difference in the refractive index between refractive-index control layer 30 and recessed and protruding layer 40. Specifically, the inclined surface of protrusion 41 functions as a light reflective surface (totally reflective surface) or a light transmissive surface.

The angle of inclination of one of protrusions 41 and the angle of inclination of another of protrusions 41 are different from each other in the recurrent direction of protrusions 41. Stated differently, protrusions 41 include protrusions 41 whose angles of inclination are different.

As illustrated in FIG. 2, in the present embodiment, recessed and protruding layer 40 is divided into three regions, namely, upper region A1, central region A2, and lower region A3 which are located in this order from the top to the bottom in a vertically downward direction. The angle of inclination of protrusions 41 in one of the regions is different from the angles of inclination of protrusions 41 in other regions. In addition, protrusions 41 in each of upper region A1, central region A2, and lower region A3 have a fixed (the same) angle of inclination.

Furthermore, in the present embodiment, the angles of inclination of protrusions 41 relative to the thickness direction decrease in the vertically downward direction. Specifically, protrusions 41 in upper region A1 have the greatest angle of inclination, protrusions 41 in lower region A3 have the smallest angle of inclination, and protrusions 41 in central region A2 have an intermediate angle of inclination between the greatest and smallest angles of inclination.

The angle of inclination of protrusions 41 in upper region A1 is, for example, greater than or equal to 10°, and preferably greater than or equal to 10° and less than or equal to 20°. The angle of inclination of protrusions 41 in lower region A3 is, for example, greater than or equal to 0° and less than or equal to 10°, and preferably less than or equal to 5°. The angle of inclination of protrusions 41 in central region A2 is, for example, greater than or equal to 0° and less than or equal to 20°, and preferably greater than or equal to 5° and less than or equal to 10°.

Each protrusion 41 of recessed and protruding layer 40 is formed into, for example, a triangular prism that is elongated in a direction perpendicular to the sheets of the drawings. The height in a cross-sectional shape is in a range from 1 μm to 10 μm, and an aspect ratio (height/base) is in a range from about 2 to 5. Note that the height and the aspect ratio of protrusions 41 are not limited to the values in such ranges. Recessed and protruding layer 40 is not limited to a layer that includes only protrusions 41, and one or more flat surfaces may be formed among protrusions 41.

Recessed and protruding layer 40 may be a conductive layer which conducts electricity. For example, recessed and protruding layer 40 can be formed using the same material as the material of first electrode 10. In this case, recessed and protruding layer 40 and first electrode 10 may be integrally formed into one, yet recessed and protruding layer 40 may be formed separately from first electrode 10. Note that the recessed and protruding surface of recessed and protruding layer 40 can be more readily formed if recessed and protruding layer 40 is formed separately from first electrode 10.

A material with which recesses and protrusions are readily formed may be used as the material of recessed and protruding layer 40, and is a resin containing material, for example. Examples of the material of recessed and protruding layer 40 include a conductive polymer and a conductive-material containing resin. An example of the conductive polymer is poly(3,4-ethylenedioxythiophene) (PEDOT). An example of the conductive material containing resin is a mixed material (conductive-material containing resin) which includes an electric conductor such as a silver nanowire, and a resin containing the electric conductor, such as cellulose and an acrylic resin. When the mixed material of a silver nanowire and a resin is used, the refractive index of recessed and protruding layer 40 can be controlled by a resin material, and thus the refractive index of recessed and protruding layer 40 can be readily brought close to the refractive index of first electrode 10 or the refractive index of refractive-index control layer 30. Accordingly, the transparency of light control device 1 in the transparent state can be improved.

Note that recessed and protruding layer 40 may be an insulating layer formed using an insulating material as long as an electric field can be applied to refractive-index control layer 30 by first electrode 10 and second electrode 20. In this case, recessed and protruding layer 40 can include an insulating resin material or an inorganic material. When recessed and protruding layer 40 includes an insulating material, voltage consumption by the recessed and protruding layer is reduced, and thus the thickness x permittivity of recessed and protruding layer 40 may be smaller than the thickness x permittivity of refractive-index control layer 30.

### [First Substrate, Second Substrate]

While a stacked structure which includes first electrode 10, second electrode 20, refractive-index control layer 30, and recessed and protruding layer 40 is disposed between first substrate 50 and second substrate 60, first substrate 50 and second substrate 60 support and protect the stacked structure. First substrate 50 and second substrate 60 are bonded together at the outer peripheries of first substrate 50 and second substrate 60 via an adhesive, for instance. In this case, the adhesive may function as a spacer which defines the length of the space between first substrate 50 and second substrate 60. For example, an adhesive in which the bead-shaped spacers are dispersed can be used.

Note that the way to fix first substrate 50 and second substrate 60 is not limited to using an adhesive to bond the substrates together, and first substrate 50 and second substrate 60 may be fixed via a spacing member having a frame shape (spacing material).

First substrate 50 and second substrate 60 are light-transmissive, and thus transmit incident light. In the present embodiment, first substrate 50 and second substrate 60 are transparent substrates, and are glass substrates or transparent resin substrates, for example. Examples of the material of a glass substrate include soda glass, alkali free glass, or high refractive-index glass, for instance. Examples of the material of a resin substrate include polyethylene terephthalate (PET), polyethylene naphthalate (PEN), polycarbonate, acrylic resin, and epoxy resin. Advantages of a glass substrate include high light transmittance (transparency) and low moisture permeability. On the other hand, an advantage of a resin substrate is that the resin substrate does not fly off much when it breaks. First substrate 50 and second substrate 60 may include the same substrate material or different substrate materials, but preferably include the same substrate material.

Note that first substrate 50 and second substrate 60 are not limited to rigid substrates, but may each be a flexible substrate such as a flexible resin substrate or a flexible glass substrate. The shapes of first substrate 50 and second substrate 60 in a plan view are each, for example, a quadrilateral shape such as a square or a rectangle, but are not limited to these, and may each be a polygonal shape other than circular and quadrilateral shapes. Arbitrary shapes may be employed for the shapes of first substrate 50 and second substrate 60.

First substrate 50 and first electrode 10 may be configured such that a difference in the refractive index is small for light in a visible light range. Such a configuration allows light to effectively pass through the interface between first substrate 50 and first electrode 10, and improves transparency in the transparent state. For example, a difference in the refractive index between first substrate 50 and first electrode 10 may be less than or equal to 0.2, and more preferably less than or equal to 0.1. Similarly, second substrate 60 and second electrode 20 may be configured such that a difference in the refractive index is small for light in a visible light range, and a difference in the refractive index between second substrate 60 and second electrode 20 may be less than or equal to 0.2, and more preferably less than or equal to 0.1. First substrate 50 and second substrate 60 may have substantially the same refractive index, and a difference in the refractive index between first substrate 50 and second substrate 60 may be less than or equal to 0.1. First electrode 10 and second electrode 20 may also have substantially the same refractive index, and a difference in the refractive index between first electrode 10 and second electrode 20 may be less than or equal to 0.1. The refractive indexes of first substrate 50, second substrate 60, first electrode 10, and second electrode 20 are within a range from 1.3 to 2.0, for example, but are not limited to the range.

### [Optical Operation of Light Control Device]

The following describes the optical operation of light control device 1 according to Embodiment 1.

Light control device 1 can transmit light. For example, light control device 1 transmits light that enters through first substrate 50, and allows the light to exit through second substrate 60. Also, light control device 1 transmits light that enters through second substrate 60, and allows the light to exit through first substrate 50.

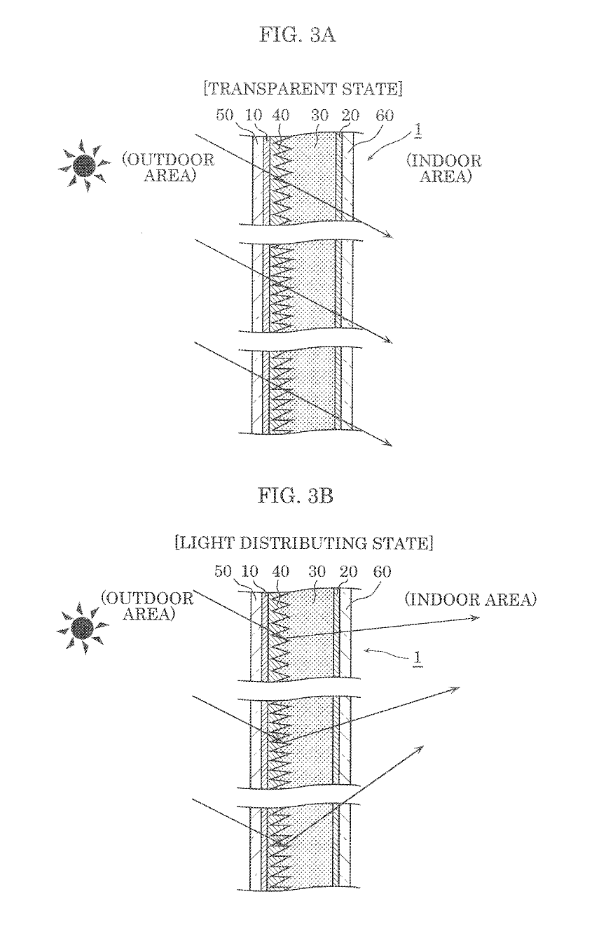

As illustrated in FIGS. 3A and 3B, light control device 1 according to the present embodiment can create the transparent state (FIG. 3A) and the light distributing state (FIG. 3B) by changing the refractive index of refractive-index control layer 30. FIG. 3A is an enlarged partial cross-sectional view schematically illustrating a state of light control device 1 according to Embodiment 1 in the transparent state. FIG. 3B is an enlarged partial cross-sectional view schematically illustrating a state of light control device 1 in the light distributing state. Note that FIGS. 3A and 3B illustrate cases where light from the outdoor area enters from the first substrate 50 side.

As illustrated in FIG. 3A, light control device 1 is in the transparent state when a voltage is not applied to first electrode 10 and second electrode 20 (during no voltage application). Specifically, an electric field is not applied to refractive-index control layer 30 when a voltage is not applied to first electrode 10 and second electrode 20, and thus the orientation state of liquid crystal molecules in refractive-index control layer 30 does not change.

In this case, a difference in the refractive index between refractive-index control layer 30 and recessed and protruding layer 40 is set to be small (for example, zero), and thus as illustrated by the arrows in FIG. 3A, light which enters light control device 1 travels straight as it is, without being bent. In other words, light which enters light control device 1 passes through light control device 1, without changing the direction of travel.

As described above, when light control device 1 is in the transparent state (FIG. 3A), light (outdoor daylight) which enters light control device 1 from the outdoor area travels straight as the light proceeds and passes through light control device 1, and is directed to the indoor area. For example, when sunlight falls on light control device 1 obliquely from above, the sunlight travels straight in a direction as it is, and enters the indoor area. Accordingly, the floor surface near the window is irradiated with the sunlight.

On the other hand, as illustrated in FIG. 3B, light control device 1 is in the light distributing state when a voltage is applied to first electrode 10 and second electrode 20 (during voltage application). Specifically, an electric field is applied to refractive-index control layer 30 when a voltage is applied to first electrode 10 and second electrode 20, and thus the orientation state of liquid crystal molecules in refractive-index control layer 30 changes.

In this case, a difference in the refractive index between refractive-index control layer 30 and recessed and protruding layer 40 is set to be large, and thus as illustrated by the arrows in FIG. 3B, light which enters light control device 1 is bent. Thus, light which enters light control device 1 changes the direction of travel and passes through light control device 1.

As described above, when light control device 1 is in the light distributing state (FIG. 3B), light control device 1 changes the direction of travel of light from the outdoor area which enters light control device 1. For example, when sunlight enters light control device 1 obliquely downwardly from obliquely above, sunlight is reflected in a direction in which light bounces off (the returning direction). Accordingly, the ceiling can be irradiated with sunlight.

As described above, light control device 1 changes between the transparent state and the light distributing state by controlling a voltage applied to first electrode 10 and second electrode 20. Thus, light control device 1 can switch between the transparent state and the light distributing state. Note that in the present embodiment, the light distributing state is created by allowing the inclined surface of protrusion 41 to totally reflect light, and thus also is a totally reflective state.

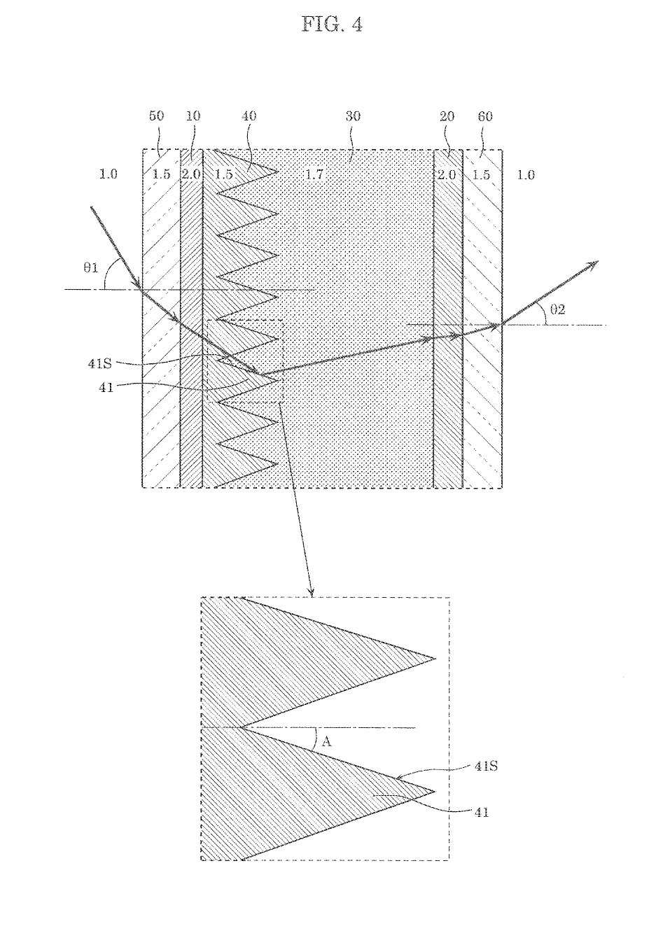

Here, a correlation between an angle of inclination of protrusion 41 of recessed and protruding layer 40 and an angle of emergence of a light ray is described in detail with reference to FIG. 4. FIG. 4 is an enlarged partial cross-sectional view of light control device 1 according to Embodiment 1 in the light distributing state.

As illustrated in FIG. 4, each protrusion 41 of recessed and protruding layer 40 has inclined surface 41S inclined at predetermined angle α of inclination relative to the thickness direction of light control device 1. Angle α of inclination of each protrusion 41 is an angle between the thickness direction of light control device 1 and the direction of inclination of inclined surface 41S of protrusion 41. Note that as illustrated in FIG. 4, each protrusion 41 having a triangular cross-sectional shape has two inclined surfaces 41S on the upper and lower sides, yet in the present embodiment, upper inclined surface 41S is a totally reflective surface due to the refractive indexes of recessed and protruding layer 40 and refractive-index control layer 30.

As illustrated in FIG. 4, θ1 is an angle of incidence of light which enters light control device 1 (such as sunlight), and θ2 is an angle of emergence when the light passes through light control device 1 and exits light control device 1.

As illustrated in FIG. 4, light which enters light control device 1 at angle θ1 of incidence sequentially refracted by and passes through first substrate 50, first electrode 10, recessed and protruding layer 40, refractive-index control layer 30, second electrode 20, and second substrate 60, and exits light control device 1 at angle θ2 of emergence.

In this case, when light control device 1 is in the light distributing state, angle θ2 of emergence has a value illustrated in Table 1 below when angle θ1 of incidence and angle α of inclination are changed. Note that the numerical values illustrated in FIG. 4 indicate the refractive index of each component member, and the refractive indexes of the air layer, first substrate 50, first electrode 10, recessed and protruding layer 40, second electrode 20, and second substrate 60 are 1.0, 1.5, 2.0, 1.5, 2.0, and 1.5, respectively.

FIG. 4 illustrates a state when light control device 1 is in the light distributing state, namely when incident light is reflected by inclined surface 41S of protrusion 41, and the refractive index of refractive-index control layer 30 at this time is 1.7.

TABLE 1

| | | ANGLE α OF INCLINATION | | | | |
|---|---|---|---|---|---|---|
| ANGLE θ2 OF EMERGENCE | | 0° | 5° | 10° | 15° | 17.5° |
| ANGLE θ1 OF | 10° | −10.0 | +7.0 | x | x | x |
| INCIDENCE | 20° | −20.0 | −2.7 | +14.4 | X | X |
| | 30° | −30.0 | −12.1 | +4.9 | +22.3 | X |
| | 40° | −40.0 | −21.1 | −3.8 | +13.3 | +22.1 |
| | 50° | −50.0 | −29.4 | −11.6 | +5.5 | +14.1 |
| | 60° | X | −36.8 | −18.3 | −1.1 | +7.5 |
| | 70° | X | X | −23.5 | −6.1 | +2.5 |
| | 80° | X | X | −26.8 | −9.2 | −0.7 |

In Table 1, the values of angle θ2 of emergence are expressed with “− (minus sign)” when incident light is reflected such that exiting light is directed toward the ceiling, expressed with “+ (plus sign)” when incident light is reflected such that exiting light is directed toward the ground, and expressed by “×” when incident light is not totally reflected (light passes through).

Specifically, a combination which results in a value with “−” in Table 1 allows incident light to be reflected by inclined surface 41S such that the direction of travel (light path) of the incident light traveling toward the ground can be bent toward the ceiling. On the other hand, a combination which results in a value with “+” allows inclined surface 41S to change the direction of travel of incident light traveling toward the ground, yet inclined surface 41S changes the direction of travel within a range in which the incident light travels toward the same ground without being bent toward the ceiling.

As is clear from Table 1, small angle α of inclination of protrusion 41 allows incident light to exit toward the ceiling. In particular, if angle α of inclination of protrusion 41 is greater than or equal to 0° and less than or equal to 15°, angle θ2 of emergence of 10° or more can be readily achieved.

### [Advantageous Effects]

The following describes advantageous effects of light control device 1 according to the present embodiment.

Light control device 1 according to the present embodiment includes refractive-index control layer 30 having a controllable refractive index, between first electrode 10 and second electrode 20. This creates the light distributing state in which light is caused to change a direction of travel and passes through and the transparent state in which light is allowed to pass through without changing a direction of travel. Specifically, single light control device 1 can be switched between the light distributing state and the transparent state.

Light control device 1 includes recessed and protruding layer 40 which includes repeating protrusions 41, between first electrode 10 and refractive-index control layer 30. Accordingly, light control device 1 can change the direction of travel of light in the light distributing state, using protrusions 41 of recessed and protruding layer 40.

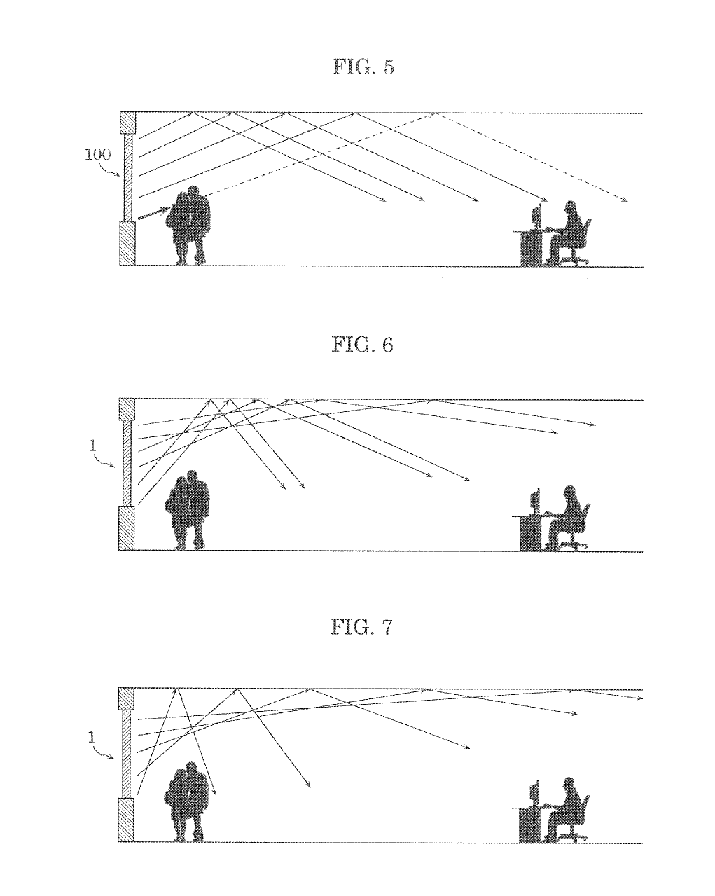

At this time, if light control device 100 in which protrusions 41 of recessed and protruding layer 40 have constant angle α of inclination over the entire region of recessed and protruding layer 40 is used, light control device 100 in the light distributing state changes the directions of all light (sunlight) rays which enter light control device 100 to the same direction, as illustrated in FIG. 5. Stated differently, inclined surfaces 41S of all protrusions 41 reflect incident light rays in the same direction, and the reflected light rays exit at the same angle of emergence.

In this case, for example, if angle α of inclination is set to an angle that allows sunlight to be directed up to a spot far from the window, light enters the eyes of a person near the window as illustrated in FIG. 5 so that the person feels that the light is too bright. On the contrary, if angle α of inclination is set to an angle that prevents light from being too bright for a person near the window, sunlight cannot reach a spot far from the window.

In view of this, in light control device 1 according to the present embodiment, among protrusions 41, one protrusion 41 and another protrusion 41 have different angles α of inclination. Specifically, protrusions 41 include protrusions 41 whose angles α of inclination are different.

Accordingly, when light control device 1 is in the light distributing state, the direction of light (sunlight) rays which enter light control device 1 is changed to different directions, and the light rays travel in the changed directions. Specifically, light rays reflected by inclined surfaces 41S of protrusions 41 having different angles α of inclination exit light control device 1 at different angles of emergence. Accordingly, light rays which enter light control device 1 can be distributed to different regions.

In this case, for example, angles α of inclination of protrusions 41 decrease in the vertically downward direction. As an example, angle α of inclination of protrusions 41 in lower region A3 of light control device 1 is set to a smaller angle (which is, for example, greater than or equal to 0° and less than or equal to 10°), angle α of inclination of protrusions 41 in upper region A1 of light control device 1 is set to a greater angle (which is greater than or equal to 10° and less than or equal to 20°).

Accordingly, as illustrated in FIG. 6, protrusions 41 located in lower region A3 of light control device 1 allow incident light to be reflected such that the incident light exits at a great angle of emergence and travels toward the ceiling on the window side (near the window), and protrusions 41 located in upper region A1 of light control device 1 allow incident light to be reflected such that the incident light exits at a small angle of emergence and travels toward the ceiling on a side far from the window in the indoor area. Accordingly, sunlight is not too bright to a person near the window, and furthermore can reach a spot far from the window.

A configuration may be adopted in which the angles of inclination of protrusions 41 gradually vary. For example, angles α of inclination of protrusions 41 can be configured to gradually decrease in the vertically downward direction.

Accordingly, as illustrated in FIG. 7, the angles of reflection at inclined surfaces 41S of protrusions 41 can be gradually changed so as to reflect incident light toward the ceiling, and thus uneven illuminance on the ceiling can be prevented. Thus, natural light can be comfortably provided all over the indoor space.

As stated above, light control device 1 according to the present embodiment can switch between the light distributing state and the transparent state, and in the light distributing state, can change the directions of incident light rays to different directions and cause the light rays to travel in the changed directions.

### EMBODIMENT 2

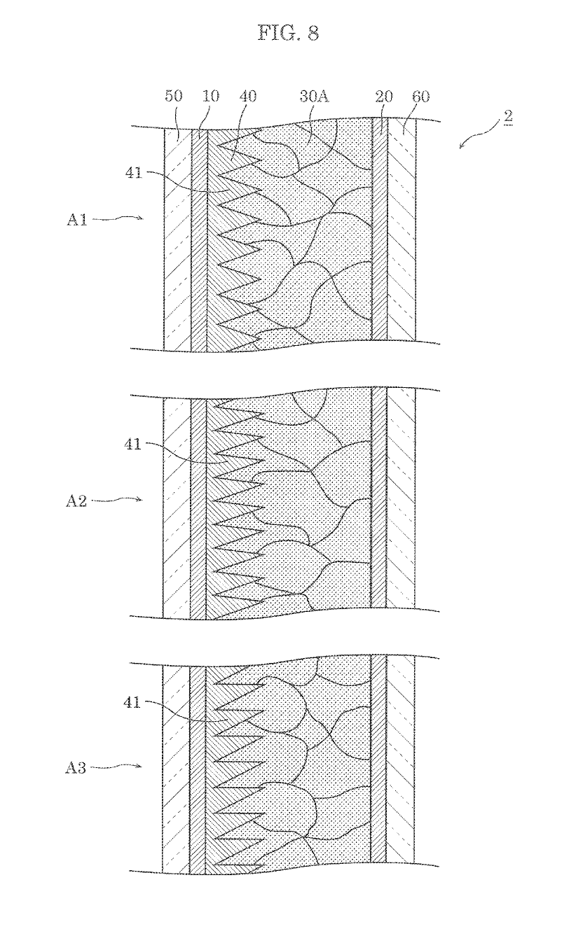

The following describes a configuration of light control device 2 according to Embodiment 2 with reference to FIG. 8. FIG. 8 is an enlarged partial cross-sectional view of light control device 2 according to Embodiment 2.

As illustrated in FIG. 8, light control device 2 includes first electrode 10 and second electrode 20 that form a pair, refractive-index control layer 30A, recessed and protruding layer 40, first substrate 50, and second substrate 60, similarly to Embodiment 1.

Light control device 2 according to the present embodiment differs from light control device 1 according to Embodiment 1 above in the configuration of refractive-index control layer 30A.

Refractive-index control layer 30A according to the present embodiment has a controllable refractive index for light in a visible light range, similarly to refractive-index control layer 30 in Embodiment 1, yet includes a liquid crystal material and a light-scattering control material, unlike refractive-index control layer 30 in Embodiment 1. Specifically, refractive-index control layer 30A includes not only a liquid crystal material, but also a light-scattering control material, and thus has controllable light-scattering properties, in addition to a controllable refractive index.

Specifically, refractive-index control layer 30A has a polymeric material (resin) having a polymer structure, as a light-scattering control material. The polymer structure may be formed by a cross-linked structure of polymer chains or entangled polymeric materials. For example, the polymer structure is a reticulated structure. The refractive index can be controlled by disposing liquid crystal molecules in the polymer structure (in the interstices of the reticulation).

For example, a polymer network liquid crystal (PNLC) or a polymer dispersed liquid crystal (PDLC) can be used, as a liquid crystal material of refractive-index control layer 30A which includes a light-scattering control material (polymeric material).

PNLC and PDLC are each configured to include a light-transmissive resin portion which includes a polymeric material and a liquid crystal portion. This configuration can change the refractive index of refractive-index control layer 30A, and also can control light scattering properties of refractive-index control layer 30A for scattering light which passes through refractive-index control layer 30A.

The resin portion is a thermosetting resin or an ultraviolet curing resin, for example, and the liquid crystal portion is a nematic liquid crystal, for instance. PNLC and PDLC may have a structure in which point-like liquid crystal portions are present in the resin portion, but may have a sea-island structure in which the resin portion corresponds to a sea while the liquid crystal portions correspond to islands. In the present embodiment, refractive-index control layer 30A has a structure in which the liquid crystal portion is irregularly connected reticulately in the resin portion, but may have a structure in which point-like resin portions are present in the liquid crystal portion, or a structure in which the resin portion is irregularly connected reticulately in the liquid crystal portion.

As described above, refractive-index control layer 30A includes a polymer material, whereby the hold of refractive-index control layer 30A improves so that material does not easily flow in refractive-index control layer 30A. In addition, refractive-index control layer 30A can well maintain a state in which the refractive index is controlled.

Similarly to refractive-index control layer 30 in Embodiment 1, application of a voltage to first electrode 10 and second electrode 20 applies an electric field to refractive-index control layer 30A. This changes the orientation state of liquid crystal molecules, thereby changing the refractive index of refractive-index control layer 30A. Specifically, the refractive index of refractive-index control layer 30A changes between two refractive indexes, namely, a refractive index having a value close to the refractive index of recessed and protruding layer 40 and a refractive index greatly different from the refractive index of recessed and protruding layer 40.

The change in refractive index also changes refractive-index control layer 30A between two states, namely, the transparent state and the light distributing state. Specifically, when the refractive index of refractive-index control layer 30A is close to or the same as the refractive index of recessed and protruding layer 40, refractive-index control layer 30A is in the transparent state, whereas when a difference in the refractive index between refractive-index control layer 30A and recessed and protruding layer 40 is large, refractive-index control layer 30A is in the light distributing state.

Note that refractive-index control layer 30A according to the present embodiment is in the light distributing state when a voltage is not applied, and is in the transparent state when a voltage is applied, unlike refractive-index control layer 30 in Embodiment 1. According to the present embodiment, refractive-index control layer 30A has light scattering properties in the light distributing state. Thus, the direction of travel of light is changed while scattering the light, rather than simply changing the direction of travel of light.

To place refractive-index control layer 30A into the light distributing state, a difference in the refractive index between refractive-index control layer 30A and recessed and protruding layer 40 is at least greater than 0.1, and is more preferably greater than or equal to 0.2. On the other hand, to place refractive-index control layer 30A into the transparent state, a difference in the refractive index between refractive-index control layer 30A and recessed and protruding layer 40 may be less than or equal to 0.2, and more preferably less than or equal to 0.1. As an example, when the refractive index of recessed and protruding layer 40 is 1.5, the refractive index of refractive-index control layer 30A in the light distributing state is 1.7, and the refractive index of refractive-index control layer 30A in the transparent state is 1.5.

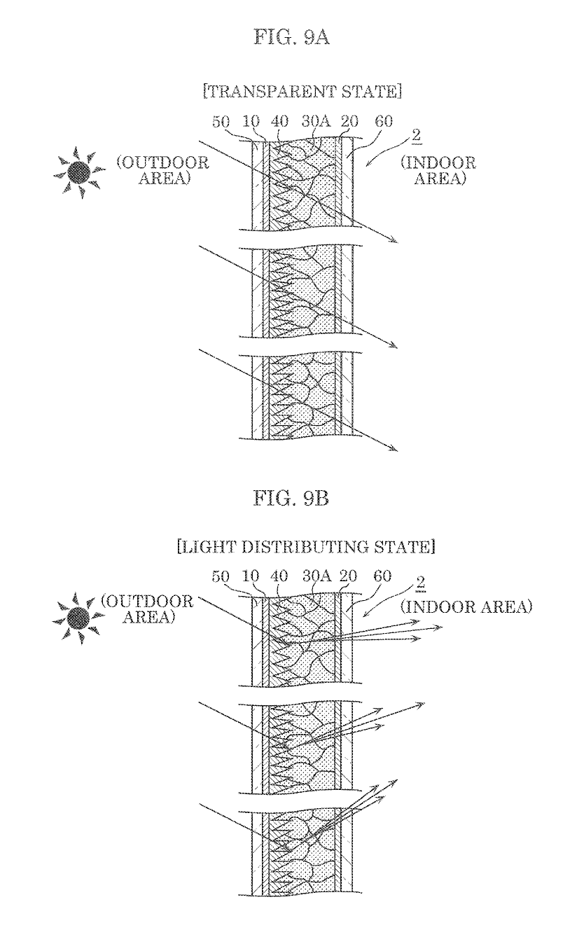

The following describes optical operation of light control device 2 according to the present embodiment with reference to FIGS. 9A and 9B. FIG. 9A is an enlarged partial cross-sectional view schematically illustrating a state of light control device 2 according to Embodiment 2 in the transparent state. FIG. 9B is an enlarged partial cross-sectional view schematically illustrating a state of light control device 2 in the light distributing state.

Light control device 2 according to the present embodiment can also create the transparent state (FIG. 9A) and the light distributing state (FIG. 9B) by changing the refractive index of refractive-index control layer 30A, similarly to Embodiment 1.

As illustrated in FIG. 9A, light control device 2 is in the transparent state when a voltage is applied to first electrode 10 and second electrode 20 (during voltage application). Specifically, an electric field is applied to refractive-index control layer 30A when a voltage is applied to first electrode 10 and second electrode 20, and thus the orientation state of the liquid crystal molecules in refractive-index control layer 30A changes.

When light control device 2 is in the transparent state, light which enters light control device 2 from the outdoor area travels straight as it is and passes through light control device 2, and comes into the indoor area.

On the other hand, as illustrated in FIG. 9B, light control device 2 is in the light distributing state when a voltage is not applied to first electrode 10 and second electrode 20 (during no voltage application). Specifically, an electric field is not applied to refractive-index control layer 30A when a voltage is not applied to first electrode 10 and second electrode 20, and thus the orientation state of the liquid crystal molecules in refractive-index control layer 30A does not change.

When light control device 2 is in the light distributing state, light which enters light control device 2 is bent, and the direction of travel of the light changes. At this time, the light which enters is scattered by refractive-index control layer 30A. Specifically, light which enters light control device 2 passes through light control device 2 while the direction of travel is being bent and the light is being scattered.

As stated above, similarly to light control device 1 according to Embodiment 1, light control device 2 according to the present embodiment includes refractive-index control layer 30A which has a controllable refractive index, between first electrode 10 and second electrode 20.

Accordingly, light control device 2 changes between the transparent state and the light distributing state, by controlling a voltage to be applied to first electrode 10 and second electrode 20. Thus, light control device 2 can also switch between the light distributing state and the transparent state.

Also in light control device 2 according to the present embodiment, among protrusions 41, protrusion 41 and another protrusion 41 have different angles α of inclination.

Accordingly, when light control device 2 is in the light distributing state, the direction of light (sunlight) rays which enter light control device 2 is changed to different directions, and the light rays travel in the changed directions. Accordingly, light rays which enter light control device 2 can be distributed to different regions.

As stated above, similarly to Embodiment 1, light control device 2 according to the present embodiment can switch between the light distributing state and the transparent state, and in the light distributing state, change the direction of incident light rays to different directions, and cause the light rays to travel in the changed directions.

Furthermore, in light control device 2 according to the present embodiment, refractive-index control layer 30A includes a liquid crystal material and a light-scattering control material, unlike Embodiment 1. Accordingly, rainbow-colored light can be prevented and white light can be obtained.

Specifically, the angle at which light is bent has wavelength dependency, and the angle at which light is bent differs for each wavelength. Accordingly, with light control device 1 according to Embodiment 1, light appears to be rainbow-colored when light control device 1 is in the light distributing state.

In view of this, in the present embodiment, refractive-index control layer 30A includes a liquid crystal material and a light-scattering control material. Specifically, refractive-index control layer 30A includes PNLC or PDLC.

Accordingly, when light control device 2 is in the light distributing state, rainbow-colored light can be diffused by refractive-index control layer 30A. As a result, light rays having different wavelengths are mixed and exit light control device 2, and thus can be caused to appear white when the light rays exit light control device 2.

### EMBODIMENT 3

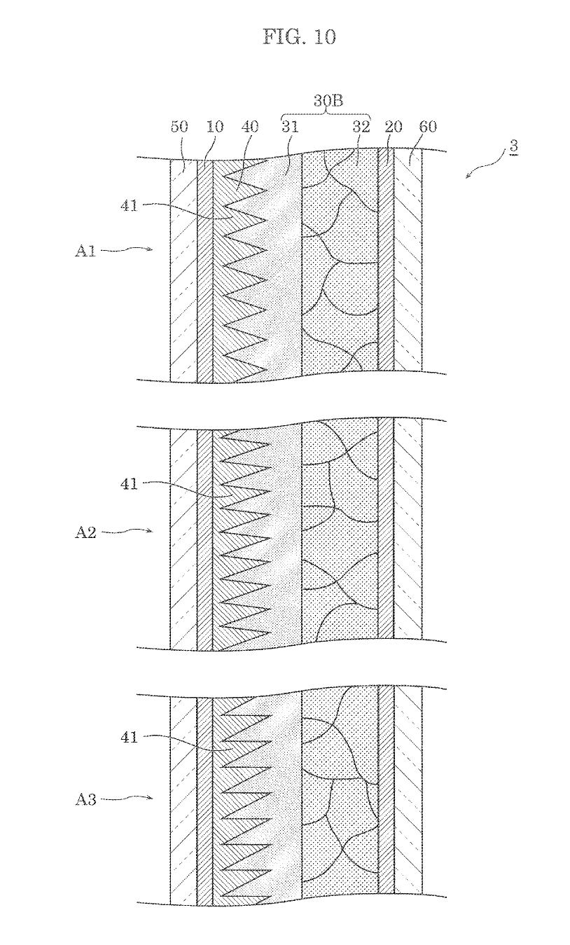

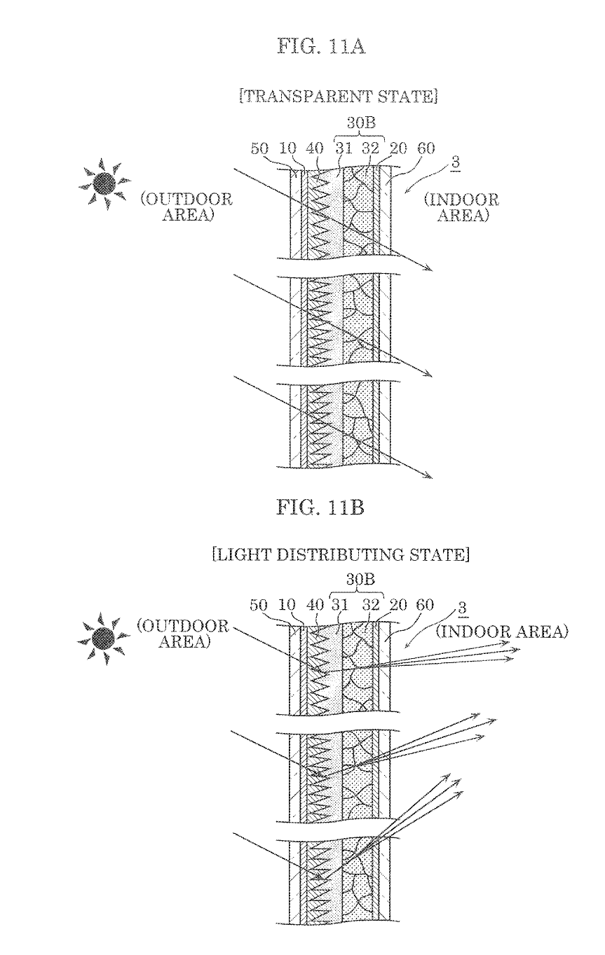

The following describes a configuration of light control device 3 according to Embodiment 3 with reference to FIG. 10. FIG. 10 is an enlarged partial cross-sectional view of light control device 3 according to Embodiment 3.

As illustrated in FIG. 10, light control device 3 includes first electrode 10 and second electrode 20 that form a pair, refractive-index control layer 30B, recessed and protruding layer 40, first substrate 50, and second substrate 60, similarly to Embodiment 1.

Light control device 3 according to the present embodiment differs from light control device 1 according to Embodiment 1 above in the configuration of refractive-index control layer 30B.

Refractive-index control layer 30B in the present embodiment has a controllable refractive index for light in a visible light range, similarly to refractive-index control layer 30 in Embodiment 1, yet unlike refractive-index control layer 30 in Embodiment 3, refractive-index control layer 30B has a structure in which first layer 31 located on a side closer to first electrode 10 and second layer 32 located on a side closer to second electrode 20 are stacked.

First layer 31 is in contact with recessed and protruding layer 40, and includes only a liquid crystal material among a liquid crystal material and a light-scattering control material. For example, first layer 31 has the same configuration as refractive-index control layer 30 in Embodiment 1, and includes, for example, a nematic liquid crystal or a cholesteric liquid crystal.

Second layer 32 is in contact with first layer 31, and includes a liquid crystal material and a light-scattering control material. For example, second layer 32 has a similar configuration to the configuration of refractive-index control layer 30A in Embodiment 2, and includes, for example, PNLC or PDLC. Note that second layer 32 is not in contact with recessed and protruding layer 40.

Note that the clear interface does not need to be present between first layer 31 and second layer 32, and the layer state may gradually change from first layer 31 to second layer 32.

An electric field is applied to refractive-index control layer 30B having such a configuration by application of a voltage to first electrode 10 and second electrode 20, similarly to refractive-index control layer 30 in Embodiment 1. Accordingly, the orientation state of liquid crystal molecules of first layer 31 and second layer 32 changes, and the refractive index of refractive-index control layer 30B changes. Specifically, the refractive index of refractive-index control layer 30B changes between two refractive indexes, namely, a refractive index having a value close to the refractive index of recessed and protruding layer 40 and a refractive index greatly different from the refractive index of recessed and protruding layer 40.

The change in refractive index changes also refractive-index control layer 30B between two states, namely the transparent state and the light distributing state. Specifically, when the refractive index of refractive-index control layer 30B is close to or the same as the refractive index of recessed and protruding layer 40, refractive-index control layer 30B is in the transparent state, whereas when a difference in the refractive index between refractive-index control layer 30B and recessed and protruding layer 40 is great, refractive-index control layer 30B is in the light distributing state.

Note that in the present embodiment, similarly to Embodiment 2, refractive-index control layer 30B is in the light distributing state when a voltage is not applied, and is in the transparent state when a voltage is applied. Also in the present embodiment, refractive-index control layer 30B has light-scattering properties when in the light distributing state. Specifically, not only the direction of travel of light is simply changed, but also the direction of travel of light is changed while the light is being scattered.

To place refractive-index control layer 30B into the light distributing state, a difference in the refractive index between refractive-index control layer 30B and recessed and protruding layer 40 is at least greater than 0.1, and is more preferably greater than or equal to 0.2. On the other hand, to place refractive-index control layer 30B into the transparent state, a difference in the refractive index between refractive-index control layer 30B and recessed and protruding layer 40 may be less than or equal to 0.2, and more preferably less than or equal to 0.1. As an example, when the refractive index of recessed and protruding layer 40 is 1.5, the refractive index of refractive-index control layer 30B in the light distributing state is 1.7, and the refractive index of refractive-index control layer 30B in the transparent state is 1.5.

The following describes optical operation of light control device 3 according to the present embodiment, with reference to FIGS. 11A and 11B. FIG. 11A is an enlarged partial cross-sectional view schematically illustrating a state of light control device 3 according to Embodiment 3 in the transparent state. FIG. 11B is an enlarged partial cross-sectional view schematically illustrating a state of light control device 3 in the light distributing state.

Light control device 3 according to the present embodiment can also create the transparent state (FIG. 11A) and the light distributing state (FIG. 11B) by changing the refractive index of refractive-index control layer 30B, similarly to Embodiment 1.

As illustrated in FIG. 11A, when light control device 3 is in the transparent state (during voltage application), light which enters light control device 3 from the outdoor area travels straight as it is and passes through light control device 3, and comes into the indoor area.

On the other hand, as illustrated in FIG. 11B, when light control device 3 is in the light distributing state (during no voltage application), light which enters light control device 3 is bent and changes the direction of travel. At this time, the light which enters is scattered by refractive-index control layer 30B. Specifically, light which enters light control device 3 passes through light control device 3 while the direction of travel is being bent and the light is being scattered.

As described above, light control device 3 according to the present embodiment includes refractive-index control layer 30B which has a controllable refractive index, between first electrode 10 and second electrode 20, similarly to light control device 1 according to Embodiment 1.

Accordingly, light control device 3 changes between the transparent state and the light distributing state, by controlling a voltage to be applied to first electrode 10 and second electrode 20. Specifically, light control device 3 can also switch between the light distributing state and the transparent state.

In light control device 3 according to the present embodiment, among protrusions 41, protrusion 41 and another protrusion 41 have different angles α of inclination.

Accordingly, when light control device 3 is in the light distributing state, the direction of light (sunlight) rays which enter light control device 3 is changed to different directions, and the light rays travel in the changed directions. Accordingly, light rays which enter light control device 3 can be distributed to different regions.

As described above, light control device 3 according to the present embodiment can switch between the light distributing state and the transparent state, and in the light distributing state, can change the direction of incident light to different directions and cause the incident light to travel in the changed directions, similarly to Embodiment 1.

In light control device 3 according to the present embodiment, refractive-index control layer 30B includes second layer 32 which includes a liquid crystal material and a light-scattering control material, similarly to Embodiment 2. Accordingly, when light control device 3 is in the light distributing state, second layer 32 of refractive-index control layer 30B can diffuse rainbow-colored light, and thus light that exits light control device 3 can be caused to appear white.

Furthermore, refractive-index control layer 30B has a structure in which first layer 31 located on a side closer to first electrode 10 and second layer 32 located on a side closer to second electrode 20 are stacked, unlike Embodiment 2. First layer 31 includes only a liquid crystal material among a liquid crystal material and a light-scattering control material, and second layer 32 includes a liquid crystal material and a light-scattering control material. Specifically, in the present embodiment, second layer 32 which includes the liquid crystal material and the light-scattering control material is not in contact with recessed and protruding layer 40. Accordingly, intended light distribution can be achieved when light control device 3 is in the light distributing state.

Specifically, with light control device 2 according to Embodiment 2 above, refractive-index control layer 30A which includes a liquid crystal material and a light-scattering control material allows light which appears rainbow-colored to be white light, yet protrusions 41 of recessed and protruding layer 40 are covered with the light-scattering control material (polymer) included in refractive-index control layer 30A, and thus intended light distribution is not readily obtained.

In view of this, with light control device 3, since refractive-index control layer 30B has a structure in which first layer 31 and second layer 32 are stacked, second layer 32 which includes a liquid crystal material and a light-scattering control material is prevented from being in contact with recessed and protruding layer 40. Accordingly, the precision of light distribution control by recessed and protruding layer 40 can be improved. As a result, in the light distributing state, light control device 3 can cause light which appears rainbow-colored to be white light, and also allows light to exit light control device 3 such that the light is distributed in an intended desired manner.

### EXAMPLES

The following describes examples and comparative examples of a light control device actually produced.

### Example 1

A light control device according to Example 1 has the configuration of light control device 2 according to Embodiment 2 above, and was produced as follows, using PNLC as the material of refractive-index control layer 30A.

First, a glass substrate (having a thickness of 0.7 mm) was used as first substrate 50 for the outdoor area side, and an indium tin oxide (ITO) film (having a thickness of 100 nm) was formed as first electrode 10 on the surface of the glass substrate. Furthermore, recessed and protruding layer 40 having a refractive index of 1.5 and a thickness of 10 μm and including an acrylic resin was formed on the surface of the ITO film by imprinting, to obtain an outdoor-area electrode substrate. At this time, angle α of inclination of protrusions 41 of recessed and protruding layer 40 located on the upper half from the middle was 10°, and angle α of inclination of protrusions 41 of recessed and protruding layer 40 located on the lower half from the middle was 5°.

Next, a glass substrate (having a thickness of 0.7 mm) was used as second substrate 60 for the indoor area side, and an ITO film (having a thickness of 100 nm) was formed on the surface of the glass substrate as second electrode 20, to obtain an indoor-area electrode substrate.

Next, the outdoor-area electrode substrate and the indoor-area electrode substrate were bonded together with a plurality of spacers each having a grain size of 30 μm therebetween. PNLC (PNM-170) manufactured by DIC Inc. was poured into the space between the outdoor-area electrode substrate and the indoor-area electrode substrate, and PNLC was cured by ultraviolet exposure of 0.5 mW. Refractive-index control layer 30A was thus formed.

### Example 2

A light control device according to Example 2 has the configuration of light control device 3 according to Embodiment 3 above, and was produced as follows using a liquid crystal material as the material of first layer 31 of refractive-index control layer 30B and PNLC as the material of second layer 32.

First, similarly to Example 1, a glass substrate (having a thickness of 0.7 mm) was used as first substrate 50 for the outdoor area side, and an ITO film (having a thickness of 100 nm) was formed on the surface of the glass substrate as first electrode 10. Furthermore, recessed and protruding layer 40 having a refractive index of 1.5 and a thickness of 10 μm and including an acrylic resin was formed on the surface of the ITO film by imprinting. The outdoor-area electrode substrate was thus obtained. At this time, angle α of inclination of protrusions 41 located on the upper half from the middle was 10°, and angle α of inclination of protrusions 41 located on the lower half from the middle was 5°.

Next, a glass substrate (having a thickness of 0.7 mm) was used as second substrate 60 for the indoor area side, and an ITO film (having a thickness of 100 nm) was formed on the surface of the glass substrate as second electrode 20. Furthermore, PNLC (PNM-170) manufactured by DIC Inc. was applied onto the ITO film, and PNLC was cured by ultraviolet exposure of 5 mW to form second layer 32. The indoor-area electrode substrate was thus obtained. Note that a desired thickness of second layer 32 (PNLC) was 10 μm.

Next, the outdoor-area electrode substrate and the indoor-area electrode substrate were bonded together with a plurality of spacers having a grain size of 30 μm therebetween, and a liquid crystal (mlc⋅2169) manufactured by Merck & Co. was poured into the space between the outdoor-area electrode substrate and the indoor-area electrode substrate, to form first layer 31.

### Comparative Example 1

A light control device according to Comparative Example 1 was the light control device according to Example 1 above in which angles α of inclination of protrusions 41 of recessed and protruding layer 40 were uniformly set to 10° over the entire region. Specifically, protrusions 41 of recessed and protruding layer 40 located on both the upper half from the middle and the lower half from the middle had angle α of inclination of 10°.

### Comparative Example 2

A light control device according to Comparative Example 2 was the light control device according to Comparative Example 1 in which the recessed and protruding layer was formed on the surface of the ITO film of the indoor-area electrode substrate, rather than on the outdoor-area electrode substrate. In other words, first substrate 50 above which recessed and protruding layer 40 was formed was disposed on the indoor area side, rather than on the outdoor area side.

### (Evaluation Results)

White parallel light was caused to enter samples according to Examples 1 and 2 and Comparative Examples 1 and 2 such that angle θ1 of incidence was 40°, and angle θ2 of emergence of the light and characteristics of the light that exits the samples were evaluated. Note that uniformity of wavelength of light that exits the samples was evaluated by viewing the light (whether the light appeared rainbow-colored). Table 2 below shows the results.

TABLE 2

| | ANGLE θ2 OF EMERGENCE | | | | |
|---|---|---|---|---|---|
| | (UPWARD FROM HORIZONTAL PLANE) | | WHETHER PERSON | PERCENTAGE | |
| | UPPER HALF | LOWER HALF | INSIDE IS LESS | OF BENT LIGHT | UNIFORMITY OF |
| | REGION (UPPER | REGION (LOWER | LIKELY TO FEEL | TO INCIDENT | WAVELENGTH OF |
| | PORTION OF WINDOW) | PORTION OF WINDOW) | LIGHT IS BRIGHT | LIGHT | EXITING LIGHT |
| EXAMPLE 1 | 4° | 21° | YES | <10% | UNIFORM |
| | | | LESS LIKELY | | (WHITE LIGHT) |
| | | | TO FEEL LIGHT | | |
| | | | IS BRIGHT | | |
| EXAMPLE 2 | 4° | 21° | YES | ABOUT 30% | UNIFORM |
| | | | LIKELY LESS | | (WHITE LIGHT) |
| | | | TO FEEL LIGHT | | |
| | | | IS BRIGHT | | |
| COMPARATIVE | 4° | 4° | NO | <10% | UNIFORM |
| EXAMPLE 1 | | | FEELS LIGHT | | (WHITE LIGHT) |
| | | | IS BRIGHT | | |
| COMPARATIVE | 4° | 4° | NO | <10% | NOT UNIFORM |
| EXAMPLE 2 | | | FEELS LIGHT | | (RAINBOW- |
| | | | IS BRIGHT | | COLORED LIGHT) |

As illustrated in Table 2, in Examples 1 and 2, angle θ2 of emergence in a lower half region (lower portion of the window) is large, and thus a person in the indoor area is less likely to feel that light is too bright. Nevertheless, in Comparative Examples 1 and 2, angle θ2 of emergence in a lower half region (lower portion of the window) is small, and thus a person in the indoor area feels that light is too bright.

According to Example 1 and Comparative Examples 1 and 2, PNLC is in contact with the surface of the recessed and protruding layer, and a large amount of polymer is present on the surface of the protrusions. Thus, the amount of bent light is decreased. Yet, in Example 2, PNLC is not in contact with the surface of the recessed and protruding layer, and almost no polymer is present on the surface of the protrusions, and thus the amount of bent light is increased.

Further, in Comparative Example 2, incidence light is diffused by PNLC, and thereafter reflected by the incline surface (reflective surface) of the protrusion of the recessed and protruding layer, and thus the exiting light appears rainbow-colored, and wavelength uniformity decreases. Yet, in Examples 1 and 2, incidence light is reflected by the inclined surface of the protruding portion of the recessed and protruding layer, and thereafter diffused by PNLC, and thus exiting light appears white. Examples 1 and 2 are, therefore, superior to Comparative Example 2 in wavelength uniformity.

### Other Variations etc.

The above completes description of the optical control devices according to the present invention, based on the embodiments and the examples, yet the present invention is not limited to the above embodiments and the above examples.

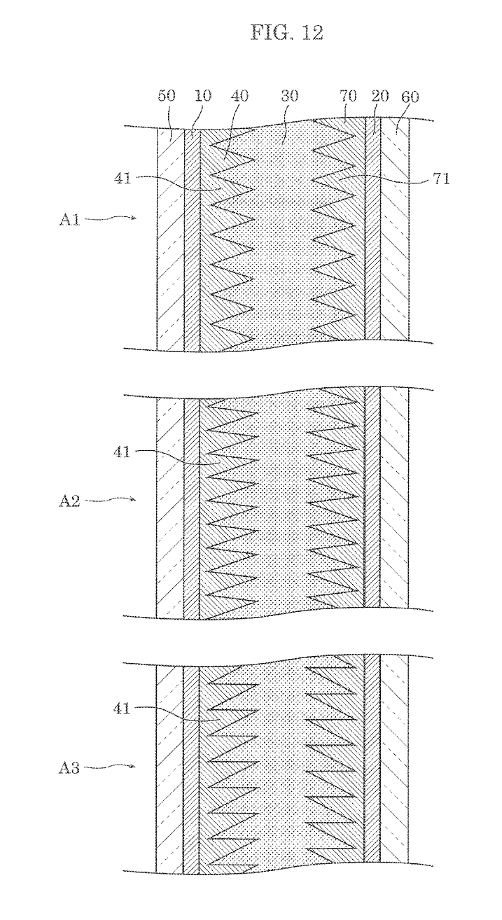

For example, in the above embodiments, recessed and protruding layer 40 is disposed only on a side closer to first electrode 10, but as illustrated in FIG. 12, recessed and protruding layer 70 may be disposed also on a side closer to second electrode 20. The optical control device illustrated in FIG. 12 has a configuration according to Embodiment 1 in which recessed and protruding layer 40 is a first recessed and protruding layer, and second recessed and protruding layer 70 which is located between refractive-index control layer 30 and second electrode 20, is light-transmissive, and includes repeating protrusions 71 is further included. Accordingly, light which enters the light control device is further bent and allowed to exit.

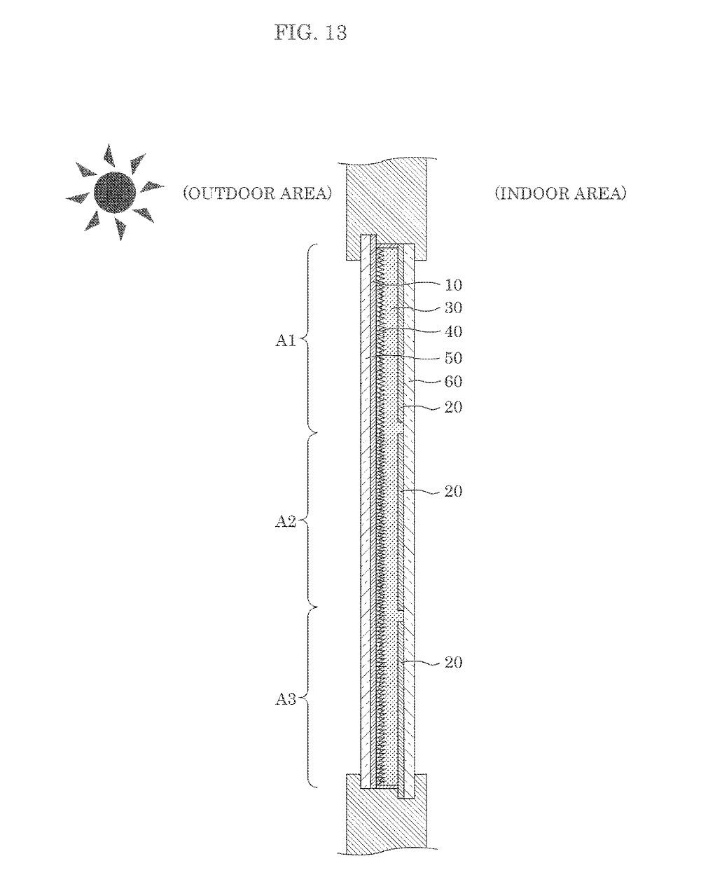

In each of the above embodiments, at least one of first electrode 10 and second electrode 20 may be divided into a plurality of portions. For example, the optical control device illustrated in FIG. 13 has the configuration according to Embodiment 1 in which second electrode 20 is divided into three regions in a plane. Accordingly, switching between the light distributing state and the transparent state can be controlled for each of the divided regions.

In each of the above embodiments, as a liquid crystal material included in the refractive-index control layer, a liquid crystal that exhibits memory effects, such as a ferroelectric liquid crystal, may be used. Accordingly, the refractive-index control layer exhibits memory effects, and thus a state in which an electric field is applied to the refractive-index control layer is maintained. Accordingly, a configuration can be achieved in which when the refractive index is to be changed, a voltage is applied to first electrode 10 and second electrode 20, whereas when a refractive index is not to be changed, a voltage is not applied to first electrode 10 and second electrode 20. Thus, power efficiency can be improved.

In the above embodiments, recessed and protruding layer 40 is divided into three regions (upper region A1, central region A2, and lower region A3) disposed in the vertical direction, and protruding portions 41 in each region have angle α of inclination different from angle α of inclination of protruding portions 41 in another region, but the present invention is not limited to this. For example, as in Examples 1 and 2, recessed and protruding layer 40 may be divided into two regions disposed in the vertical direction, and protruding portions 41 in a region have different angle α of inclination from angle α of inclination of protruding portions 41 in the other region. Alternatively, recessed and protruding layer 40 may be divided into four or more regions disposed in the vertical direction, and protruding portions 41 in a region have different angle α of inclination from angles α of inclination of protruding portions 41 in other regions. Rather than dividing recessed and protruding layer 40 into a plurality of regions disposed in the vertical direction, recessed and protruding layer 40 may be divided into a plurality of regions disposed in the horizontal direction (lateral direction), and protruding portions 41 in a region may have different angle α of inclination from angles α of inclination of protruding portions 41 in other regions. Recessed and protruding layer 40 may be divided into a plurality of regions disposed in the vertical and horizontal directions, and protruding portions 41 in a region may have different angle α of inclination from angles α of inclination of protruding portions 41 in other regions.

In Embodiment 1 above, the light control device is in the transparent state when a voltage is not applied and is in the light distributing state when a voltage is applied, yet the light control device may be configured in an opposite manner, depending on the type of a liquid crystal and a structure of the refractive-index control layer. Specifically, a configuration may be adopted in which the light control device is in the transparent state when a voltage is applied and is in the light distributing state when a voltage is not applied. For example, in Embodiment 1, using a positive type liquid crystal as a liquid crystal material can achieve the light distributing state when a voltage is not applied, and can achieve the transparent state when a voltage is applied.

Similarly, in Embodiments 2 and 3 above, the light control device is in the transparent state when a voltage is applied, and is in the light distributing state when a voltage is not applied. Yet, a configuration may be adopted in which the light control device is in the transparent state when a voltage is not applied, and is in the light distributing state when a voltage is applied.

In Embodiment 1 above, although a nematic liquid crystal is used as a liquid crystal material, a twist nematic liquid crystal (TN liquid crystal) may be used in this case.

Note that the present invention also encompasses embodiments as a result of adding, to the embodiments, various modifications that may be conceived by those skilled in the art, and embodiments obtained by combining elements and functions in the embodiments in any manner as long as the combination does not depart from the spirit of the present disclosure.

1. A light control device disposed between an outdoor area and an indoor area, the light control device comprising:
a first electrode which is light-transmissive;
a second electrode which is light-transmissive;
a refractive-index control layer located between the first electrode and the second electrode, and having a refractive index that is controllable; and
a recessed and protruding layer located between the first electrode and the refractive-index control layer, and including repeating protrusions, the recessed and protruding layer being light-transmissive, wherein
the light control device is disposed such that the first electrode is on an outdoor area side,
the repeating protrusions each have an inclined surface which is inclined at an angle of inclination that is predetermined, relative to a thickness direction of the light control device, and
the angle of inclination of one of the repeating protrusions and the angle of inclination of another of the repeating protrusions are different from each other in a recurrent direction of the repeating protrusions.

2. The light control device according to claim 1, wherein the angles of inclination of the repeating protrusions decrease in a vertically downward direction.

3. The light control device according to claim 1, wherein
the angles of inclination of the repeating protrusions gradually vary.

4. The light control device according to claim 1, wherein
the refractive-index control layer includes a liquid crystal material.

5. The light control device according to claim 1, wherein
the refractive-index control layer includes a liquid crystal material and a light-scattering control material.

6. The light control device according to claim 1, wherein
the refractive-index control layer has a structure in which a first layer located on a side closer to the first electrode and a second layer located on a side closer to the second electrode are stacked,
among a liquid crystal material and a light-scattering control material, the first layer includes only the liquid crystal material, and
the second layer includes the liquid crystal material and the light-scattering control material.

7. The light control device according to claim 1, wherein
the repeating protrusions include a first protrusion, and a second protrusion the angle of inclination of which is smaller than the angle of inclination of the first protrusion,
the angle of inclination of the first protrusion is greater than or equal to 10° and less than or equal to 20°, and the angle of inclination of the second protrusion is greater than or equal to 0° and less than or equal to 10°.

8. The light control device according to claim 1, wherein
the recessed and protruding layer is a first recessed and protruding layer,
the light control device further comprising:
a second recessed and protruding layer located between the refractive-index control layer and the second electrode, and including repeating protrusions, the second recessed and protruding layer being light-transmissive.

9. The light control device according to claim 1, wherein
at least one of the first electrode and the second electrode is divided into a plurality of portions.
